(19) United States
(12) Patent Application Publication
(10) Pub. No.: US 2001/0048996 A1
(43) Pub. Date: Dec. 6, 2001

(54) Child's security blanket

(76) Inventor: Robin Bieber-Schneider, West Grove, PA (US)

Correspondence Address: Steven J. Gelman, Klehr, Harrison, Harvey,, Branzburg & Ellers, 260 South Broad Street, Philadelphia, PA, 19102, US

(21) Appl. No.: 09/870,600

(22) Filed: May 31, 2001

Related U.S. Application Data
(60) Provisional application No. 60/208,174, filed on May 31, 2000.

(51) Int. Cl. B32B 3/02

(52) U.S. Cl. 428/99; 428/192

(57) ABSTRACT

A security blanket includes a blanket portion having an outer edge and an interior, and a handle portion attached to the outer edge of the blanket portion, such that a pocket is formed between the blanket portion on one side and the handle portion on an opposite side, the pocket having an opening facing the interior of the blanket portion.

### CROSS REFERENCE TO RELATED APPLICATIONS

This is a § 111(a) application relating to U.S. Application Ser. No. 60/208,174 filed May 31, 2000.

### FIELD OF THE INVENTION

The present invention relates to a child's security blanket, and, more particularly, to a child's security blanket having an integrated fabric handle by which a child can drag the blanket.

### BACKGROUND OF THE INVENTION

Every child has a favorite toy or blanket that they carry or drag with them wherever they go. Such a “security blanket” is generally held by the child by an edge or a corner of the blanket in the child's fist. It would be easier for the child if there were another way to hold the blanket; e.g., by a handle of some sort. Preferably, the handle would be made of the same or similar fabric as the rest of the blanket. Safety considerations dictate that the handle must be integrally formed with the blanket and designed such that the handle does not present a choking or strangulation hazard. Ideally, such a handle would be formed as an open pocket at one edge of the blanket.

U.S. Pat. No. 5,443,880 recites a beach towel or blanket having a plurality of pockets attached to one corner of the towel. The '880 patent discloses several embodiments, including multiple pockets located at one corner of the towel, single pockets located at multiple corners of the towel, and waterproof pockets. All of these pockets, however, are designed to completely contain items therein (i.e., to be closeable). While the pockets include an opening, they do not permit the towel to be dragged by inserting a hand into one of the pockets without the potential for encountering the closing mechanism (e.g., a zipper or VELCRO), which could cause injury to a child.

### SUMMARY OF THE INVENTION

A security blanket constructed in accordance with the present invention includes a blanket portion and a triangular handle portion attached to one corner of the blanket portion, preferably by stitching the portions together. The handle portion is only stitched on the outer two sides of the triangle, leaving the side of the triangle facing the interior of the blanket free, thereby forming a pocket at the corner of the blanket portion. Optionally, a logo patch may be affixed to the handle portion.

In a preferred embodiment, a security blanket includes a blanket portion having an outer edge and an interior, and a handle portion attached to the outer edge of the blanket portion, such that a pocket is formed between the blanket portion on one side and the handle portion on an opposite side, the pocket having an opening facing the interior of the blanket portion.

### BRIEF DESCRIPTION OF THE DRAWINGS

For a better understanding of the present invention, reference is made to the following detailed description of an exemplary embodiment considered in conjunction with the accompanying drawings, in which:

FIG. 1 is a top plan view of a security blanket constructed in accordance with the present invention; and

FIG. 2 is an enlarged side view of the blanket shown in FIG. 1.

### DETAILED DESCRIPTION OF THE INVENTION

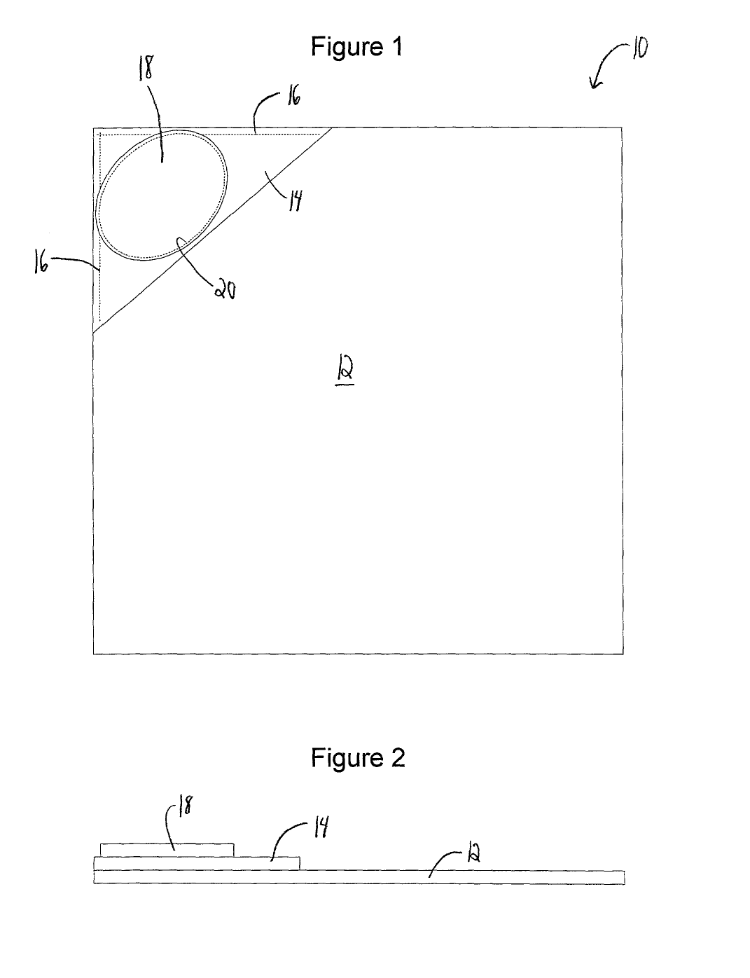

As shown in FIGS. 1 and 2, a security blanket 10 has a square blanket portion 12 and a triangular handle portion 14. The handle portion 14 is attached to the blanket portion 12 in a secure manner, preferably by stitching 16, along the two outer edges of the blanket portion 12. The edge of the handle portion 14 that faces the center of the blanket portion 12 is not attached, thereby forming a pocket having an opening that faces toward the interior of the blanket portion 12 and extends toward the outer edges of the blanket portion 12. A logo patch 18 can be affixed to the handle portion 14 in a secure manner, preferably by stitching 20.

It will be understood that the embodiment described herein is merely exemplary and that a person skilled in the art may make many variations and modifications without departing from the spirit and scope of the present invention. For instance, while the shape of the blanket portion is shown as being square, any other shape can be used, such as rectangular, triangular, or round. With a rectangular or triangular blanket portion, the handle portion would still be attached to a corner of the blanket portion. With a circular blanket portion, the handle portion would be constructed as a semi-circle and would be attached to the blanket portion along the circumference of the blanket portion. In addition, any means for securely attaching the handle portion to the blanket portion may be employed, provided that there are no sharp edges on which a child may be injured and that the handle portion cannot be easily separated from the blanket portion. All such variations and modifications are intended to be included within the scope of the invention as defined in the appended claims.

What is claimed is:

1. A security blanket, comprising:
a blanket portion having an outer edge and an interior; and
a handle portion attached to said outer edge of said blanket portion, such that a pocket is formed between said blanket portion on one side thereof and said handle portion on an opposite side thereof, said pocket having an opening facing said interior of said blanket portion.

2. A security blanket according to claim 1, further comprising a logo patch attached to said handle portion.

3. A security blanket according to claim 1, wherein said blanket portion is square and said handle portion is triangular.

4. A security blanket according to claim 1, wherein said blanket portion is rectangular and said handle portion is triangular.

5. A security blanket according to claim 1, wherein said blanket portion is triangular and said handle portion is triangular.

6. A security blanket according to claim 1, wherein said blanket portion is round and said handle portion is semi-circular.
